(19) United States
(12) Patent Application Publication
(10) Pub. No.: US 2016/0159435 A1
(43) Pub. Date: Jun. 9, 2016

(54) Electrical Motor for a Bicycle

(71) Applicants: Arie Leon Yehuda, Anissaras (GR); Alan Oken, Raanana (IL); Ariel Napchi, Tel Aviv (IL)

(72) Inventors: Arie Leon Yehuda, Anissaras (IL); Alan Oken, Raanana (IL); Ariel Napchi, Tel Aviv (IL)

(21) Appl. No.: 14/960,530

(22) Filed: Dec. 7, 2015

Related U.S. Application Data
(60) Provisional application No. 62/088,725, filed on Dec. 8, 2014.

(51) Int. Cl. B62M 6/55; F16D 41/12; B62M 9/00; B62K 11/04; B62M 6/90

(52) U.S. Cl. CPC B62M 6/55; B62K 11/04; B62M 6/90; B62M 9/00; F16D 41/12

(57) ABSTRACT

An electric motor that is installed on a bicycle frame that includes a first side, a second side, and a bottom bracket shell. The electric motor contains a first portion, disposed on the first side of the frame of the bicycle frame proximate the bottom bracket, and a second portion, disposed on the second side of the bicycle frame proximate the bottom bracket shell. The first portion of the electric motor includes a stator and a rotor. The second portion of the electric motor includes a rechargeable battery. A bicycle crankset, with two crank arms, two pedals, and an axle, is rotatably coupled to the bottom bracket shell of the bicycle frame, where the axle of the crankset extends through the first and second portions of the electric motor. The rotor includes a sprocket that intermeshes with a bicycle chain to drive a rear wheel coupled to the bicycle frame.

### CROSS REFERENCE TO RELATED APPLICATIONS

This application claims priority to and the benefit of U.S. Provisional Patent Application No. 62/088,725, filed Dec. 8, 2014, entitled “Electrical Motor for a Bicycle,” the contents of which are hereby incorporated by reference in their entirety.

### FIELD OF THE INVENTION

Present invention embodiments relate to an electrical motor that is able to be coupled to a frame for powering a bicycle or other vehicle. In particular, the electrical motor may be coupled to nearly any typical bicycle frame without making alterations of the bicycle frame. The electrical motor may be configured to solely power the bicycle or provide pedal assistance to a user.

### BACKGROUND

Bicycles are one of the most popular modes for transportation. They are often used because bicycles provide an easy, low maintenance, and simple mode of transportation. In cities, where road congestion is common, bicycles are often considered one of the fastest ways to get around. However, bicycles typically require a significant amount of physical output by a user, especially when the terrain ridden over is not flat. Because of the physical output required when riding a bicycle, many users arrive to their destinations overly exhausted, out of breath, or even sweating. Because of their convenience and ease for getting around, many users would use their bicycles to get to work, run errands at the store, or even for a visit to a friend's house if it wasn't for the physical output needed for riding a bicycle.

Many bicycles have been created that include an electric motor to assist the user of the bicycle to ride over terrain without needing the physical output of a normal bicycle. However, many of these bicycles are specially designed bicycles that incorporate motors into or onto the frame, which requires users to purchase an entirely separate bicycle. The bicycle frames that already include a motor are also often expensive. Furthermore, many of the motor systems used on bicycles today are bulky, heavy, and cumbersome to operate. In addition, the motors may be equipped on the bicycle in a manner that creates a weight imbalance on the bicycle. On some bicycles, the motor may be disposed on the rear wheel of the bicycle, which makes maintenance a time consuming and expensive task. Furthermore, if the rear wheel is ever damaged, the bicycle is rendered inoperable until the wheel can be fixed.

A present invention embodiment is directed generally to an electric motor system that can be incorporated onto nearly any bicycle frame without altering the frame of the bicycle. This eliminates the need for having multiple bicycles, or purchasing a new bicycle. Furthermore, a present invention embodiment provides an electric motor system that can be installed on the bicycle frame without creating a weight imbalance on the bicycle. The electric motor system may also be symmetrical in size and shape to be visually appealing when installed on the bicycle frame.

### SUMMARY

According to one exemplary embodiment, the present invention includes an electric motor system that is coupleable to a bicycle frame as shown and described herein.

According to a second embodiment, the present invention includes an apparatus that includes a frame, at least one wheel, an axle, a first crank arm, a second crank arm, a motor, and a chain. The frame is a bicycle frame that includes a first side, a second side, and a bottom bracket. The axle includes a first end and a second end. The axle is rotatably coupled within the bottom bracket of the frame, where the first end of the axle extends from the first side of the frame and the second end of the axle extends from the second side of the frame. The first crank arm is operatively coupled to the first end of the axle, and the second crank arm is operatively coupled to the second end of the axle. The first and second crank arms are configured to rotate the axle with respect to the frame. Moreover, rotation of the first crank arm causes rotation of the second crank arm, and vice versa, via the axle.

The motor includes a first motor portion and a second motor portion. The first motor portion includes at least a stator and a rotor, with a sprocket disposed along the exterior surface of the rotor. The second motor portion includes a rechargeable battery. The first portion and the second portion are electronically connected to one another. The first motor portion is disposed on the frame between the first side of the frame and the first crank arm proximate the bottom bracket of the frame. The first end of the axle extends through the first portion of the motor. The second motor portion is disposed on the frame between the second side of the frame and the second crank arm proximate the bottom bracket of the frame. The second end of the axle extends through the second portion of the motor. The first motor portion and the second motor portion are substantially equal in weight, size, and shape.

Furthermore, the at least one wheel is coupled to the frame and includes a hub and a second sprocket that is fixed to the hub. The chain is coupled to the first sprocket and the second sprocket so that rotation of the rotor drives the chain to rotate the second sprocket, and thus the at least one wheel. Because the second sprocket is fixed to the hub of at least one wheel, rotation of the at least one wheel also drives the chain to cause rotation of the rotor. When the motor is not powered, and the at least one wheel is rotating, the rotation of the at least one wheel causes the chain to rotate the rotor. The interaction between the rotating rotor and the stator when the motor is not powered creates a current that recharges the battery.

### BRIEF DESCRIPTION OF THE DRAWINGS

FIG. 1 illustrates a side view of a bicycle equipped with an electric motor system according to an embodiment of the present invention.

FIG. 2 illustrates a perspective view of the opposite side of the bicycle illustrated in FIG. 1.

FIG. 3 illustrates a top view of the electric motor system installed on the frame of the bicycle illustrated in FIG. 1.

FIG. 4 illustrates an exploded view of a portion of the electric motor system that is installed on the bicycle illustrated in FIG. 1.

FIG. 5 illustrates a second exploded view of the portion of the electric motor system illustrated in FIG. 4.

FIG. 6 illustrates an interior view of the rotor of the electric motor system illustrated in FIG. 4.

FIG. 7 illustrates an exterior view of the rotor of the electric motor system illustrated in FIG. 4.

FIG. 8 illustrates a perspective view of the battery of the electric motor system that is installed on the bicycle illustrated in FIG. 1.

FIG. 9 illustrates a perspective view of a second embodiment of the battery of the electric motor system that is installed on the bicycle illustrated in FIG. 1.

FIG. 10 illustrates a bottom view of the stator of the electric motor system, the stator being installed proximate to the bottom bracket of the bicycle illustrated in FIG. 1.

FIG. 11 illustrates a procedural flow chart illustrating an example manner for operation of a electronic braking system according to an embodiment of the present invention.

Like reference numerals have been used to identify like elements throughout this disclosure.

### DETAILED DESCRIPTION OF THE INVENTION

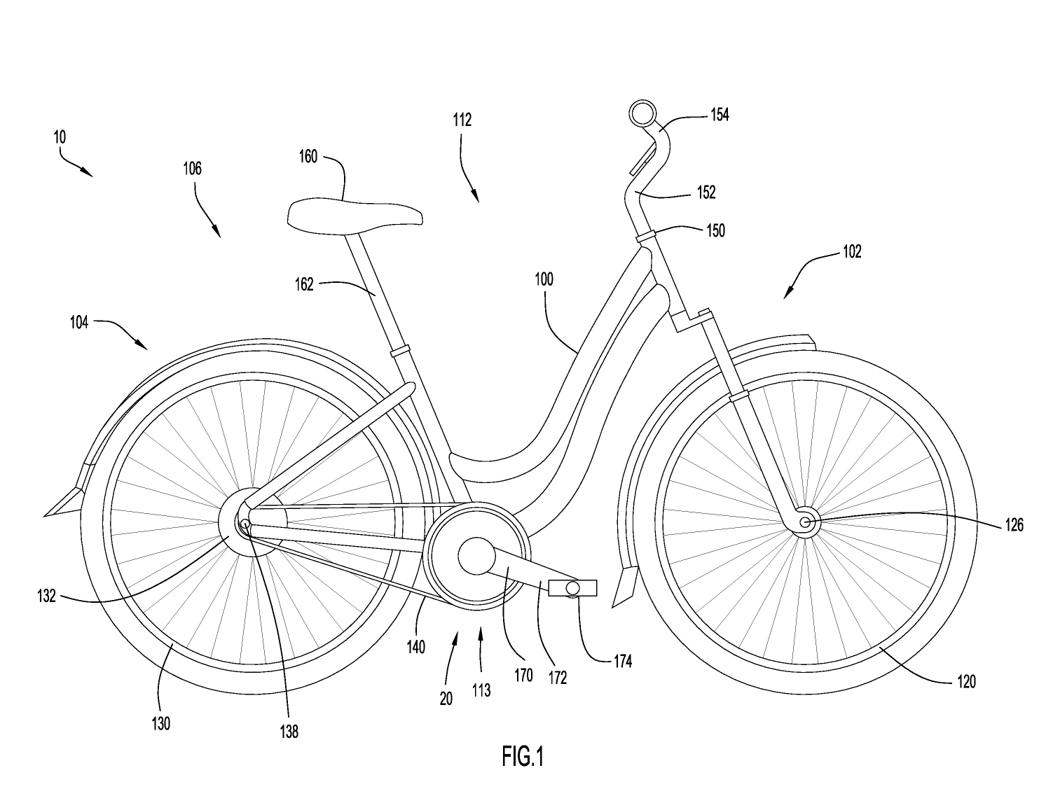

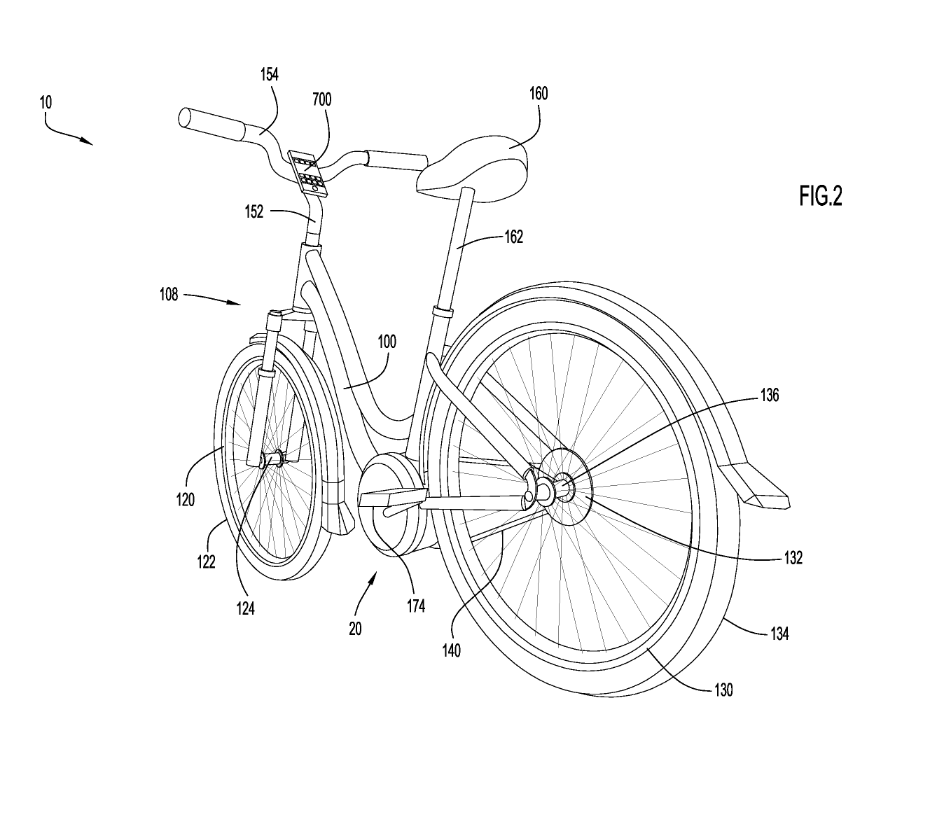

Illustrated in FIGS. 1 and 2 is a bicycle 10 that is equipped with an electric motor system 20. As illustrated in FIGS. 1 and 2, the bicycle 10 resembles that of an ordinary bicycle 10. The bicycle 10 includes a bicycle frame 100, where the frame has a front 102, a rear 104, a right side 106, and a left side 108. The bicycle frame 100 also includes a top 112 and a bottom 113. As included in most bicycle frames, the bicycle frame 100 of a present invention embodiment includes a front wheel 120 disposed on the bicycle frame 100 proximate to the front 102 of the bicycle 10, and a rear wheel 130 disposed on the bicycle frame 100 proximate to the rear 104 of the bicycle 10. As illustrated in FIGS. 1 and 2, the front wheel 120 includes a tire 122 disposed around the circumference of the front wheel 120, a hub 124, and an axle 126. The hub 124 and the axle 126 serve as the attachment of the front wheel 120 to the front 102 of the frame 100 of the bicycle 10. Moreover, the front wheel 120 and the tire 122 are configured to rotate via the hub 124 about the axle 126. FIGS. 1 and 2 also best illustrate that the rear wheel 130 includes a tire 134 disposed around the circumference of the rear wheel 130, a hub 136, and an axle 138. The hub 136 and the axle 138 serve as the attachment of the rear wheel 130 to the rear 104 of the frame 100 of the bicycle 10. Moreover, the rear wheel 130 and the tire 134 are configured to rotate via the hub 136 about the axle 138. The rear wheel 130 differs from the front wheel 120 in that the rear wheel 130 includes a rear sprocket, or cassette, 132 that is disposed on the hub 136 of the rear wheel 130. In the embodiment shown, the sprocket 132 is “fixed” to the hub 136, meaning that the sprocket 132 will only rotate when the hub 136 rotates. Thus, the sprocket 132 only rotates when the rear wheel 130 rotates. In many modern day bicycles, the rear sprocket may be attached to the hub of the rear wheel via a free wheel mechanism that allows the rear wheel of the bicycle “free wheel,” or rotate even when the sprocket is not rotating. The bicycle 10 in the embodiment shown does not include a freewheel mechanism because the rear sprocket 132 is fixed to the hub 136 of the rear wheel 130.

As further illustrated in FIGS. 1 and 2, a bicycle chain 140 is configured to connect the electric motor system 20 with the rear sprocket 132. Moreover, bicycle 10 is equipped with a crankset 170 that includes two crank arms 172 and two pedals 174. The right side 106 of the bicycle 10 has one crank arm 172 and one pedal 174 rotatably coupled to the end of the crank arm 172. Similarly, the left side 108 of the bicycle 10 includes another crank arm 172 and one pedal 174 rotatably coupled to the end of the crank arm 172. Each of the pedals 174 is configured to receive and support a user's foot. When the user applies force, via their feet, to the pedals 174, the crank arms 172 are rotated with respect to the frame 100 of the bicycle 10. As will be explained later, because of the type of connection that couples the crank arms 172 to the electric motor system 20, when the crank arms 172 are rotated, a portion of the electric motor system 20 begins to drive the chain 140 around the electric motor system 20. As the chain 140 is driven around the electric motor system 20, the chain 140 then drives rotation of the rear sprocket 132, and thus rotation of the rear wheel 130, to drive the bicycle 10 across a support surface.

Continuing with FIGS. 1 and 2, extending upwardly from the frame 100 of the bicycle 10 is a seat post 162 that includes a seat 160 coupled to the end of the seat post 162. The seat post 162 extends upwardly from the frame 100 of the bicycle 10 at an angle that positions the seat 160 substantially over the rear wheel 130 of the bicycle 10. Coupled to the front 102 of the bicycle frame 100 is a headset 150. Extending forward and upward from the headset 150 is a stem 152, which holds a set of handlebars 154. As best illustrated in FIG. 2, the handlebars 154 and/or the stem 152 may be equipped to house or retain a portable electronic device 700, such as an iPhone® or an iPad®. In some embodiments, the portable electronic device 700 may be attachable to just the handlebars 154 or just the stem 152.

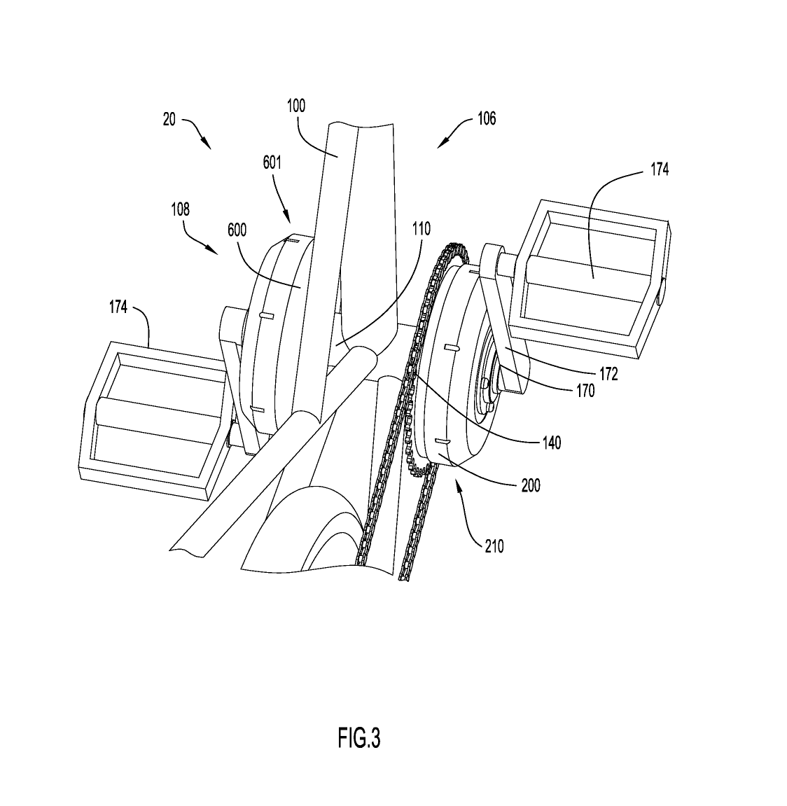

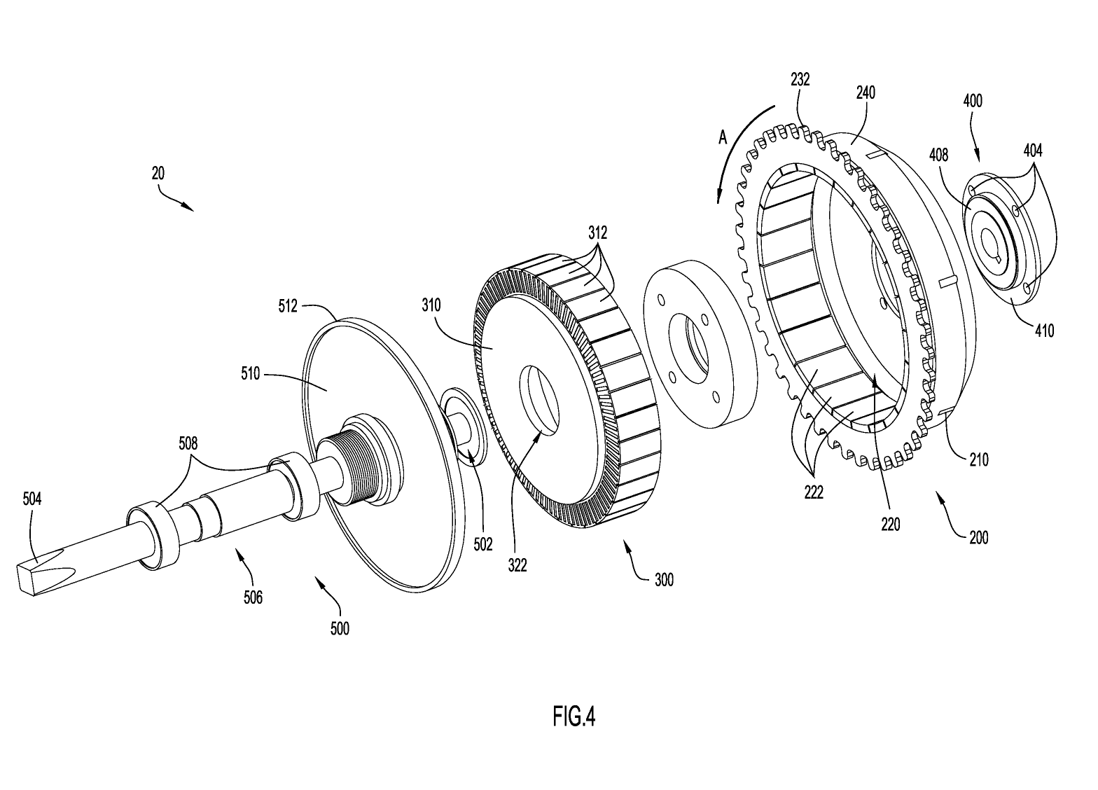

Turning to FIG. 3, illustrated is a top view of the electric motor system 20 installed on the frame 100 of the bicycle 10. As illustrated, the bicycle frame 100 includes a bottom bracket 110 that is positioned through the bottom 113 of the frame 100. Moreover, the electric motor system 20 is positioned around and through the bottom bracket 110 of the bicycle frame 100 of the bicycle 10. As further explained in detail later, the electric motor system 20 includes a first portion 210 and a second portion 601. The first portion 210 includes a rotor 200 surrounding a stator 300 (illustrated in FIGS. 4, 5, and 9), and is installed on the right side 106 of the bicycle frame 100. The second portion 601 is the battery 600 installed on the left side 108 of the bicycle frame 100. As best illustrated in FIG. 3, it can be seen that the first portion 210 is substantially equal in size and weight to that of the second portion 601. For example, the diameter of the first portion 210 is substantially equal to the diameter of the second portion 601. In addition, the first portion 210 may be substantially equal to, or a mirror image of, the second portion 601.

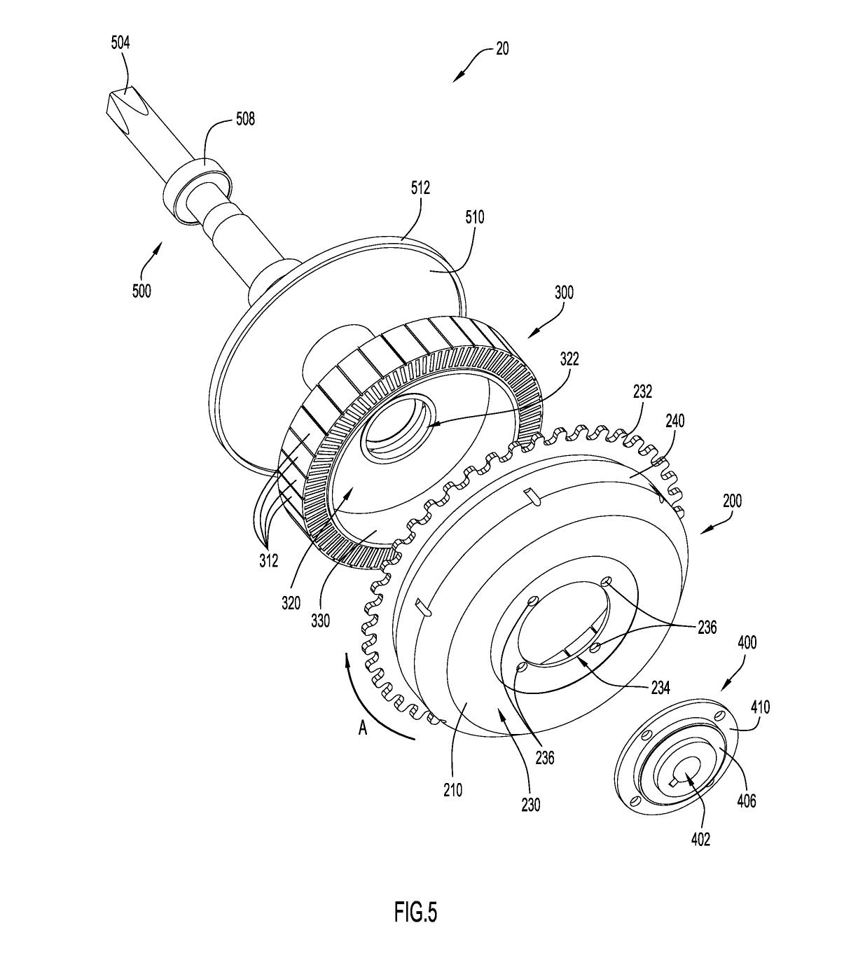

Illustrated in FIGS. 4 and 5 is an exploded view of a portion of the electric motor system 20. As illustrated, the electric motor system 20 includes a rotor 200, a stator 300, a connector 400, and an axle 500. The axle 500 includes a first end 502, a second end 504, and a central portion 506. The central portion 506 of the axle 500 is defined by bearings 508, which are configured to form a portion of the bottom bracket 110 of the bicycle frame 100. The bearings 508 are configured to rest within the bottom bracket 110 of the frame 100, and allow the axle 500 to rotate with respect to the frame 100. Moreover, with the central portion 506 of the axle 500 being installed within a portion of the bottom 113 of the frame 100, the first end 502 of the axle 500 extends from the right 106 of the frame 100 while the second end 504 of the axle 500 extends from the left 108 of the frame 100. As illustrated in FIGS. 4 and 5, the first end 502 of the axle 500 extends through at least a portion of the stator 300 and the rotor 200, and is coupled to the connector 400, which is coupled to the crank arm 172 on the right side 106 of the bicycle frame 100. Moreover, the second end 504 of the axle 500 is configured to extend through the battery 600, and is coupled to the crank arm 172 on the left side 108 of the bicycle frame 100.

Continuing with FIGS. 4 and 5, coupled to the axle 500 between the first end 502 of the axle 500 and the central portion 506 of the axle 500 is a sealing plate 510. The sealing plate 510 may be substantially circular in shape. Furthermore, the sealing plate 510 may include a rubber portion 512 coupled to the periphery of the sealing plate 510. The sealing plate 510 may be configured to rotate with the axle 500, or may remains stationary as the axle 500 rotates with respect to the frame 100 of the bicycle 10.

Moreover, the stator 300 is configured to be installed around the axle 500 proximate to the first end 502 of the axle 500 and the sealing plate 510. The stator 300 is rotatably coupled to the axle 500, where the stator 300 remains stationary as the axle 500 rotates. As illustrated, the stator 300 includes an exterior surface 310 and an interior surface 320. The stator 300 may be substantially circular in shape with a flange 330 that extends along the periphery of the stator 300. The flange 330 defines the interior surface 320. The stator 300 includes a central opening 322 that extends through the exterior surface 310 and the interior surface 320. The first end 502 of the axle 500 extends through the central opening 322 of the stator 300. The stator 300 further includes a series of magnets 312 that are coupled to the exterior surface 310 of the stator 300 along the flange 330. The magnets 312 of the stator 300 are preferably electromagnets that are coupled to coils or windings to control the electromagnetic field to impart rotation of the rotor 200.

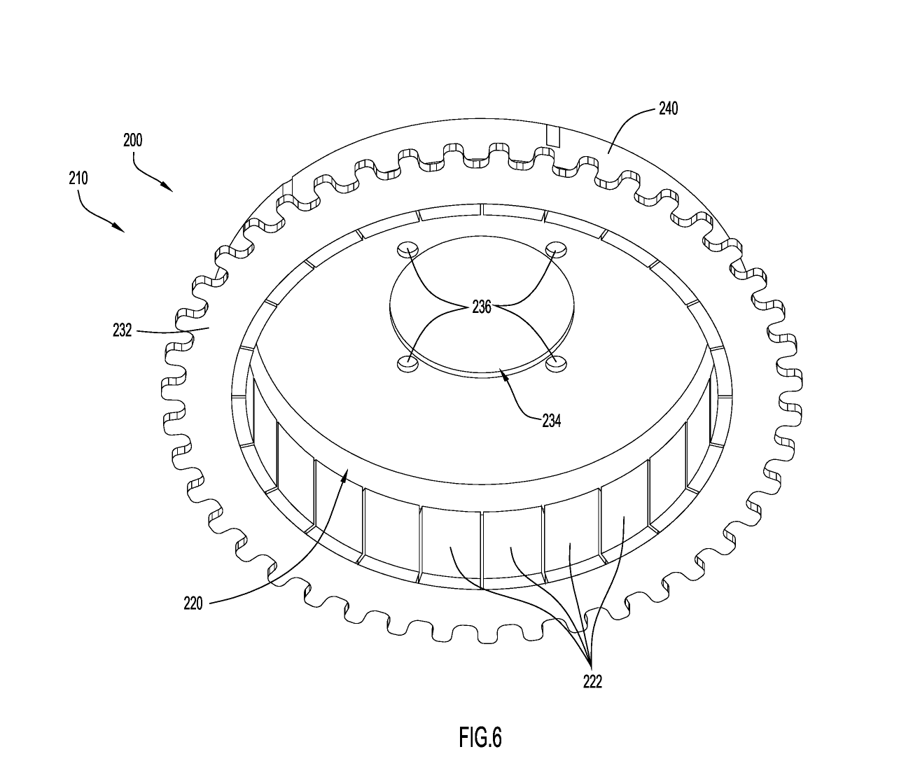

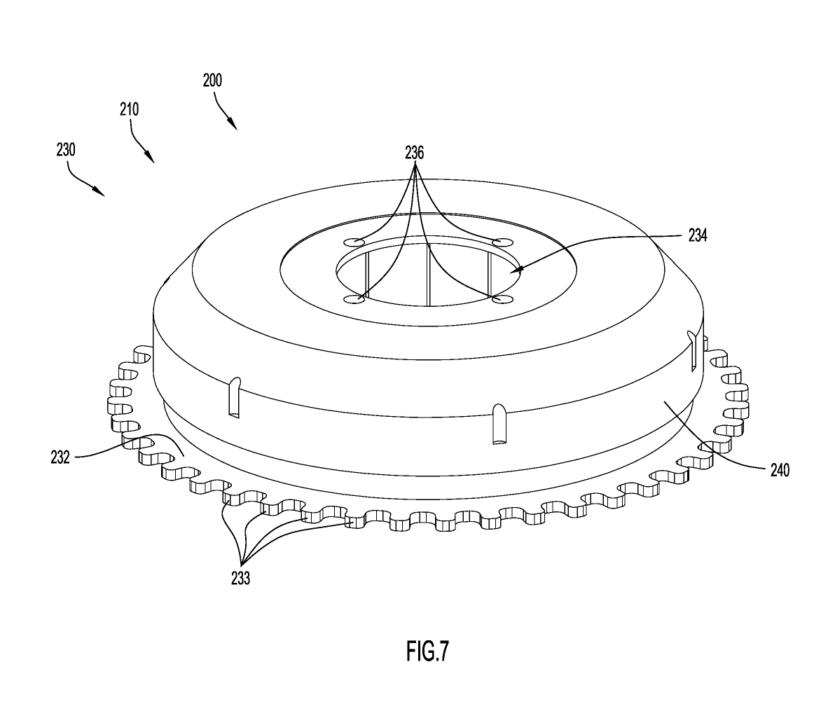

Illustrated in FIGS. 4, 5, 6, and 7 is the rotor 200 of the electric motor system 20. The rotor 200 is sized and shaped to cover the stator 300. The rotor 200 has an exterior surface 230 and an interior surface 220. The combination of the rotor 200 being positioned around and over the stator 300 forms a section of the first portion 210 of the electric motor system 20. The rotor 200 may be substantially circular in shape, and includes a flange 240 that extends along the periphery of the rotor 200. Similar to that of the stator 300, the flange 240 of the rotor 200 defines the interior surface 220 of the rotor 200. Positioned along the flange 240 on the interior surface 220 is a series of magnets 222. The magnets 222 of the rotor 200 may be permanent magnets. The rotor 200 further includes a front sprocket 232 that is coupled to the exterior surface 230 of the rotor 200 along the flange 240 of the rotor 200. The sprocket 232 includes a series of equally spaced teeth 233 that are sized and configured to intermesh with the bicycle chain 140. Furthermore, the rotor 200 includes a central opening 234 and multiple smaller apertures 236 equally spaced around the central opening 234. The smaller apertures 236 are configured to receive screws or other similar connectors. In the embodiment illustrated, the rotor 200 has a weight of 1.5 kg to 2 kg. The enhanced weight of the rotor 200 provides momentum to reduce pedaling effort needed by the user. Because of the weight of the rotor 200, when the motor system 20 is not being powered, the rotor 200 may act as an inertia wheel, or flywheel, while the user is pedaling the bicycle 10. With the rotor 200 acting as an inertia wheel, a user will receive 5-10% more speed and acceleration compared to a bicycle without a motor system 20. The rotor 200 acting as an inertia wheel may also cause the bicycle 10 to travel a farther distance in the same amount of time as that of a bicycle without a motor system 20.

FIGS. 4 and 5 also illustrate a connector 400 that couples to the exterior surface 230 of the rotor 200 around to the central opening 234 of the rotor 200. The connector 400 is substantially circular in shape, and includes an outer surface 406, an inner surface 408, and a flange 410 that extends from the periphery of the connector 400. A central opening 402 extends through the connector 400 between the outer surface 406 and the inner surface 408. The inner surface 408 of the connector 400 is configured to be placed against the exterior surface 230 of the rotor 200 when the connector 400 is coupled to the rotor 200. In the embodiment shown in FIGS. 4 and 5, at least a portion of the inner surface 408 of the connector 400 extends into the central opening 234 of the rotor 200. Moreover, the flange 410 that extends around the periphery of the connector 400 has a diameter greater than that of the central opening 234 of the rotor 200, which prevents the connector 400 from sliding through the central opening 234 of the rotor 200. Furthermore, equally spaced around the flange 410 is a set of apertures 404, where the number of apertures 404 on the flange 410 of the connector 400 is equal to the number of smaller apertures 236 on the exterior surface 230 of the rotor 200. The apertures 404 on the flange 410 are sized and spaced to align with the small apertures 236 that are positioned around the central opening 234 of the rotor 200. Thus, screws or other similar fasteners can be used to couple the connector 400 to the exterior surface 230 of the rotor 200. While not illustrated, the connector 400 may include a set of bearings and/or a ratchet and pawl system disposed internally within the connector 400.

When the electric motor system 20 is fully assembled, the combination of the sealing plate 510, stator 300, rotor 200 and connector 400 forms the first portion 210 of the electric motor system 20 that extends from the right side 106 of the frame 100 of the bicycle 10, illustrated in FIGS. 1 and 3. Moreover, as illustrated best in FIGS. 4 and 5, the diameter of the rotor 200 is larger than the diameter of the stator 300, so that, when the electric motor system 20 is assembled, the rotor 200 encapsulates the stator 300. In the embodiment shown, the stator 300 has a diameter of approximately 145 mm to 155 mm, while the rotor 200 has a diameter of approximately 155 mm to 165 mm. The flange 240 of the rotor 200 extends over the flange 330 of the stator 300 such that the flange 240 of the rotor 200 rests proximate to the rubber portion 512 of the sealing plate 510, positioning the stator 300 within a casing formed by the sealing plate 510 and the rotor 200. The sealing plate 510 is configured to prevent moisture and dust from getting into the electric motor system 20. When fully assembled, the permanent magnets 222 of the rotor 200 are aligned with the electromagnets 312 of the stator 300. Therefore, when the electromagnets 312 of the stator 300 are powered to form a magnetic field, the magnetic field interacts with the permanent magnets 222 of the rotor 200 to impart torque and rotation to the rotor 200. Thus, the rotor 200 and the stator 300 form an outrunner, or external rotor, configuration of a brushless direct current (DC) motor. In the embodiment illustrated, the magnets 222, 312 may have a width of 25 mm. Furthermore, the brushless DC motor illustrated may have an output range of 250 to 500 watts.

In addition, when the electric motor system is fully assembled, the first end 502 of the axle 500 extends through the central opening 322 of the stator 300, and at least partially through the central opening 234 of the rotor 200. In some embodiments the first end 502 of the axle 500 will extend through the central opening 402 of the connector 400 to be coupled with the crank arm 172 on the right side 106 of the frame 100 of the bicycle 10. In other embodiments, the crank arm 172 may extend through the central opening 402 of the connector 400 to be coupled to the first end 502 of the axle 500. In either embodiment, the crank arm 172 on the right side 106 of the frame 100 of the bicycle 10 and the first end 502 of the axle 500 are configured to be coupled with the bearings and the ratchet and pawl system within the connector 400. Thus, when force is imparted onto the crank arm 172 in the forward direction, the pawl will engage the ratchet, causing rotation of the rotor 200 in direction A (illustrated in FIGS. 4 and 5), and thus the sprocket 232 to drive the bicycle chain 140. However, the ratchet and pawl system also allows the rotor 200 to rotate in direction A (illustrated in FIGS. 4 and 5) when the crank arm 172 and the axle 500 are stationary, enabling the electric motor system 20 to operate without the user having to pedal the bicycle 10. Furthermore, when force is imparted onto the crank arm 172 in the rearward direction, the pawl will not engage the ratchet, and does not cause the rotor 200 to rotate in any direction.

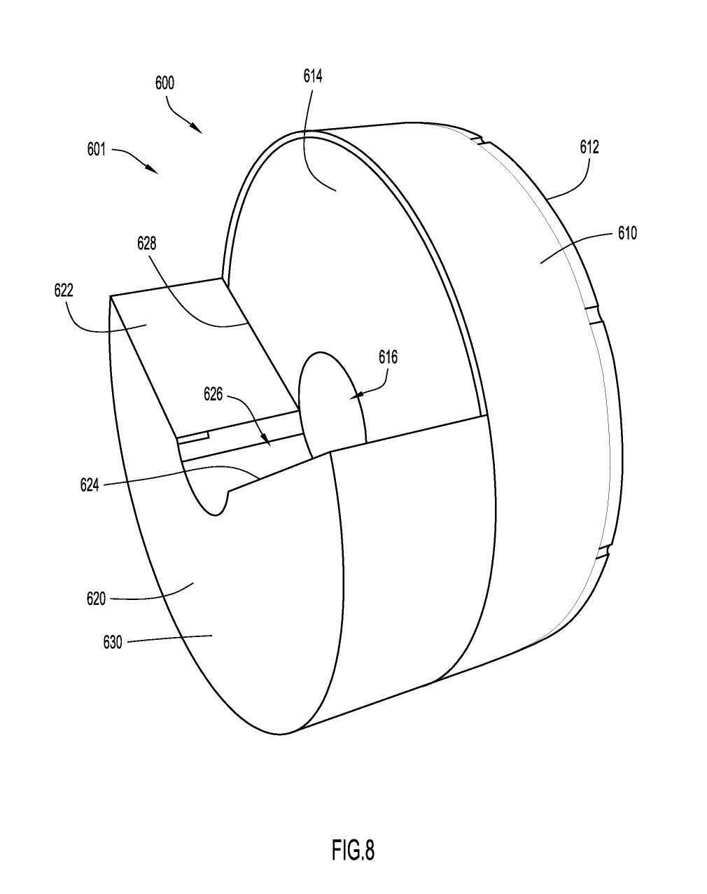

Turning to FIG. 8, illustrated is a perspective view of the battery 600. The battery 600 includes a first portion 610 and a second portion 620. The first portion 610 is substantially cylindrical in shape with an outer surface 612 and an inner surface 614. Furthermore, there is a central opening 616 that extends through the first portion 610 so that the second end 504 of the axle 500 can extend through the battery 600 to be connected to the crank arm 172 on the left side 108 of the frame 100 of the bicycle 10. The second portion 620 of the battery 600 is substantially cylindrical in shape with a portion of the cylinder removed. This leaves the second portion 620 with a first angled portion 622, a second angled portion 624, and channel 626. The second portion 620 further includes an outer surface 630 and an inner surface 628. The first portion 610 is coupled to the second portion 620 so that the inner surface 614 of the first portion 610 abuts the inner surface 628 of the second portion 620. Moreover, the channel 626 of the second portion 620 is aligned with the central opening 616 of the first portion 610.

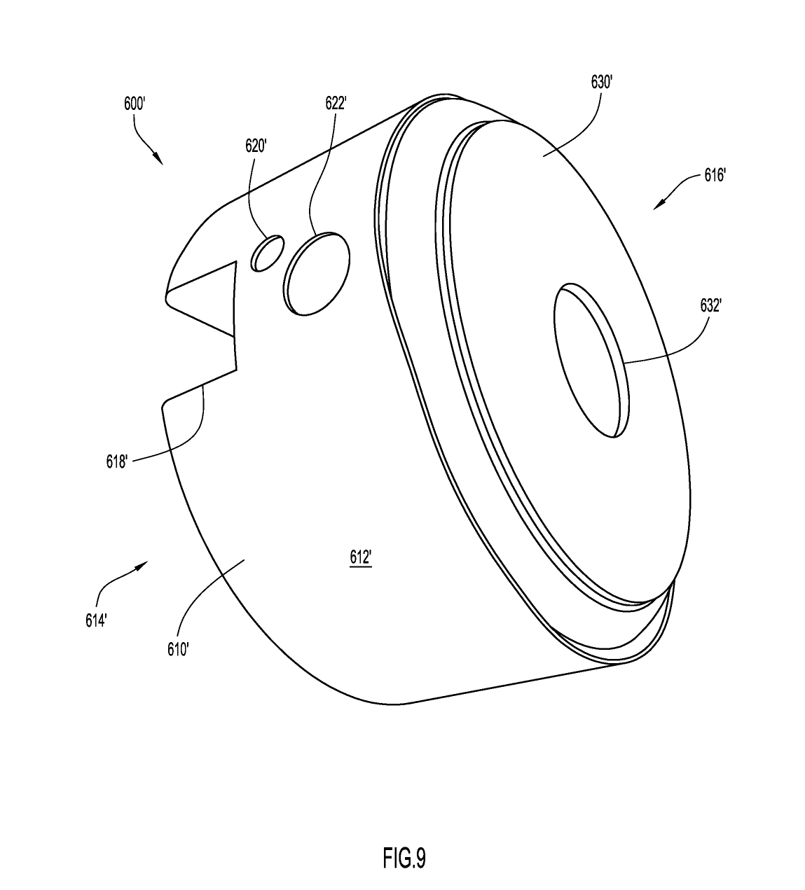

Turning to FIG. 9, illustrated is a perspective view of a second embodiment of the battery 600′. The battery 600′ includes an outer housing 610′ and a cover 630′. The outer housing 610′ is substantially cylindrical in shape with an outer surface 612′, a first side 614′, and a second side 616′ disposed opposite of the first side 614′. Furthermore, disposed on the outer surface 612′ of the outer housing 610′ is a first opening 618′, a second opening 620′, and a third opening 622′. The first opening 618′ is substantially rectangular and disposed proximate to the first side 614′ of the outer housing 610′. The first opening 618′ is sized and shaped to receive at least a portion of one of the chainstays 116 (illustrated in FIG. 9) located proximate to the bottom bracket 110. The first opening 618′ enables the battery 600′ to be positioned against the bottom bracket 110. Furthermore, the second and third openings 620′, 622′ are substantially circular and may be disposed between the first opening 618′ and the second side 616′. The second and third openings 620′, 622′ may enable access to the interior of the battery 600′. As further illustrated in FIG. 9, the cover 630′ covers the second side 616′ of the outer housing 610′. The cover 630′ includes a central opening 616 that extends through the cover 630′ so that the second end 504 of the axle 500 can extend through the battery 600′ to be connected to the crank arm 172 on the left side 108 of the frame 100 of the bicycle 10.

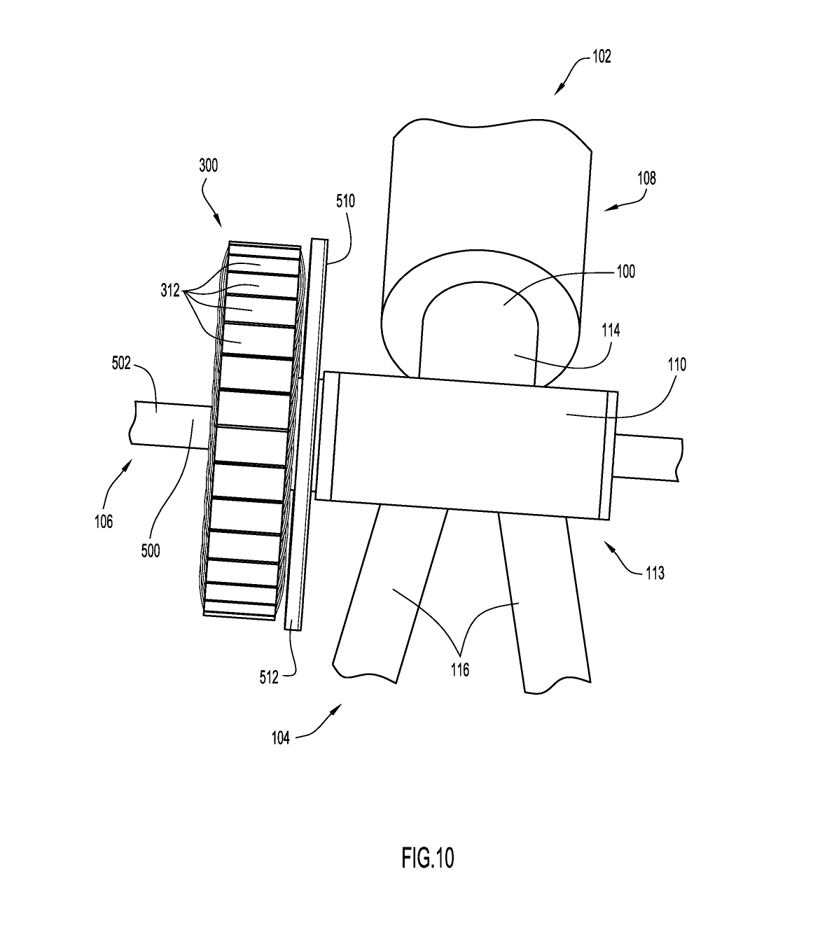

Turning to FIG. 10, illustrated is the bottom 113 of a bicycle frame 100 with only an axle 500, the stator 300, and the sealing plate 510 coupled to the bicycle frame 100. As illustrated, the bicycle frame 100 includes a bottom bracket 110 at the bottom 113 of the frame 100, where a downtube 114 extends from the bottom bracket 110 upward toward the front 102 of the bicycle 10. Moreover, extending from the bottom bracket 110 towards the rear 104 of the bicycle 10 is a pair of chainstays 116. As illustrated in FIG. 10, the stator 300 is positioned on the right side 106 of the bottom bracket 110. While not illustrated in FIG. 10, the left side 108 of the bottom bracket 110 would include the battery 600. When coupled to the frame 100 of the bicycle 10, the inner surface 614 of the first portion 610 of the battery 600 may be positioned proximate to the left side 108 of the bottom bracket 110, while the second portion 620 of the battery 600 is positioned beneath and around a portion of the bottom bracket 110. It is the shape of the second portion 620 of the battery 600, and specifically the first and second angled portions 622, 624 with the channel 626, that allows the battery 600 to be coupled to the left side 108 of the frame 100 of the bicycle 10, proximate the bottom bracket 110.

The electric motor system 20 is designed to be coupled to nearly any bicycle frame 100 without requiring alterations to the bicycle frame 100. Thus, a user may be able to purchase the electric motor system 20 to equip their preexisting bicycle 10 with an electric motor. The electric motor system 20 is easily equipped to most bicycle frames 100 because the axle 500 of the electric motor system 20 can be inserted through the bottom bracket 110 of the bicycle frame 100, and then the first portion 210 of the electric motor system 20 can be equipped to the first end 502 of the axle 500 on the right side 106 of the frame 100 proximate to the bottom bracket 110, and the second portion 601 of the electric motor system 20 can be equipped to the second end 504 of the axle 500 on the left side 108 of the frame 100 proximate to the bottom bracket 110. Thus, as best illustrated in FIGS. 1-3 the entire electric motor system 20, when mounted on the bicycle frame 100, is positioned between both crank arms 172 and the two pedals 174. The electric motor system 20 may be available as a kit to install on existing bicycles, or may be pre-included on, or form part of, a new bicycle.

As previously explained, the first portion 210, which is formed from primarily the stator 300 and the rotor 200, is equivalent in size, weight, and shape to that of the second portion 601. Thus, when the electric motor system 20 is equipped to a bicycle frame 100, the bicycle is balanced both visually and with respect to the weight distribution from the left side 108 to the right side 106 of the frame 100. Because the first portion 210 and the second portion 601 are equal in weight, neither the right side 106 nor the left side 108 of the bicycle 10 will be heavier than the other. The center of gravity of the bicycle frame 100 remains in the center of the bicycle frame 100. This provides optimum efficiency and handling capabilities to the bicycle 10. With the first portion 210 and second portion 601 being substantially identical is size and shape, the bicycle 10 remains symmetrical on each side 106, 108. In addition, while not illustrated, all electrical wiring of the electric motor system 20 is configured to remain internal to the electrical motor system 20. This keeps the electric motor system 20 clean and prevents any wear and tear to the wiring from debris.

During operation of the bicycle 10 equipped with the electric motor system 20, the electric motor system 20 may be controlled by a portable electronic device 700, as illustrated in FIGS. 1 and 2. The portable electronic device 700 allows the user of the bicycle 10 to control the output range of the electric motor system 20. In one embodiment, the user may be able to set a preferred level of assistance by the electric motor system 20 from 0 to 100 percent. When the level of assistance set is 0 percent, only the pedaling of the user will power the bicycle 10 to travel along a support surface. When the level of assistance is set to a value between 0 and 100 percent, the electric motor system 20 combined with the pedaling by the user powers the bicycle 10 to travel along a support surface. Finally, when the level of assistance is set to a value of 100 percent, the electric motor system 20 is capable of powering the bicycle 10 to travel along a support surface without the need for a user to pedal.

In addition, the electronic device 700 may be equipped with map software that takes into account elevation data and grade data of the road. The electronic device 700 may be further equipped with a global positioning system (GPS) sensor to track the location of the bicycle 10. The map software together with the GPS sensor enables map software to track the exact location of the bicycle. As the bicycle 10 travels along a support surface, such as a road or trail, the electronic device 700 may adjust the power output of the electric motor system 20 based on the elevation and grade of the support surface, as indicated by the map software.

In some embodiments, when a portable electronic device 700 is not able to be used (e.g., user does not have a portable electronic device 700, or the user's portable electronic device 700 is incompatible with the electric motor system 20), the bicycle 10 can be equipped with a speed and output control for controlling the electric motor system 20 in the same manner as that of the portable electronic device 700. This control can be equipped on the bicycle frame 100 at various locations, including the downtube 114, the stem 152, the handlebars, 154, etc.

When the electric motor system 20 is powered, the electromagnets 312 of the stator 300, as previously explained, form a magnetic field that interacts with the permanent magnets 222 of the rotor 200 to impart torque and rotation to the rotor 200. The rotor 200 is then forced to rotate in a forward direction A (illustrated in FIGS. 4 and 5) about the axle 500 and the stator 300. As previously explained, the exterior surface 230 of the rotor 200 is equipped with a sprocket 232, where the teeth 233 of the sprocket 232 are configured to intermesh with the chain 140. Furthermore, as previously explained, the chain 140 is intermeshed with the sprocket 232 of the rotor 200 and the rear sprocket 132 of the rear wheel 130. Thus, as the rotor 200 is rotated about the axle 500 and the stator 300, the chain 140 is driven to impart rotation onto the rear sprocket 132, and subsequently onto the rear wheel 130, which drives the bicycle 10 to travel across a support surface.

As previously explained, the rear sprocket 132 of the rear wheel 130 is considered a “fixed” gear. The hub 136 of the rear wheel 130 does not contain a freewheel mechanism, and thus any rotation imparted onto the rear sprocket 132 is imparted onto the rear wheel 130. Conversely, any rotation imparted onto the wheel 130, such as coasting down a hill, causes the rear sprocket 132 to rotate, which in turn drives the chain 140, and causes the rotor 200 to rotate about the axle 500 and the stator 300. Therefore, when the bicycle 10 is coasting and the electric motor system 20 is not being powered to provide an output, the rotor 200 is forced to rotate about the stator 300. This creates a current within the electric motor system 20. While not illustrated, the electric motor system 20 internally includes a diode bridge that relays the current created by the electric motor system 20 when the bicycle is coasting to the battery 600 to recharge the battery 600. Thus, when the bicycle 10 is coasting, the battery 600 is being recharged. In other embodiments, the battery 600 may also be recharged by being plugged into an electrical power source (e.g., an electrical wall outlet or another battery).

Furthermore, the pedals 174 and the crank arms 172 do not need to rotate in order for the rotor 200 to be able to rotate because of the connector 400. As previously explained, the connector 400 may internally contain a set of ball bearings and a ratchet and pawl system. Thus, when the pedals 174 and crank arms 172 are forced to rotate in the forward direction A (illustrated in FIGS. 4 and 5) by the user pedaling the bicycle 10, the pawl will engage the ratchet within the connector 400 causing the rotor 200 rotate, which will then drive the chain 140 to rotate the rear wheel 130. However, if the user pedals the crank arms 172 and pedals 174 in the backwards direction, opposite of direction A (illustrated in FIGS. 4 and 5), the pawl will not engage the ratchet, and the rotor 200 will not be rotated by the pedaling of the user. In addition, if the rotor 200 is forced to rotate via the coasting by the bicycle 10 or being powered to rotate by the battery 600, the rotation of the rotor 200 will not cause the crank arms 172 and the pedals 174 to rotate because the ratchet within the connector 400 will be free to rotate without being engaged by the pawl within the connector 400. Thus, the rotor 200 is capable of rotating without requiring the user to pedal the crank arms 172 and the pedals 174.

Additionally, the electric motor system 20 may internally contain a set of sensors (not illustrated), such as a speed sensor/controller and a pedaling/cadence signal sensor. The speed sensor/controller is capable of detecting the speed of the bicycle 10 via the rotation of the rotor 200 and/or the pedaling output of the user. The speed sensor/controller is configured to communicate with the portable electronic device 700 to control the output and rotation of the rotor 200, and to relay the current speed of the bicycle 10 and rotational speed of the rotor 200 to the portable electronic device 700 for viewing by the user. The pedaling signal sensor (also not illustrated) detects pedal movement and adjusts the rotational speed of the rotor 200 according to the pedal assistance value set on the portable electronic device 700. The pedal sensor may be further able to determine the position of the crank arms 172. The electronic device 700 may be configured to regulate the power output by the motor system 20 and the speed of the bicycle 10 based on the pedaling pace, or cadence, of the user of the bicycle 10. For example, as the user of the bicycle increases their cadence, the electronic device 700 may output more power to increase the speed of the bicycle 10 until the user reduces their cadence.

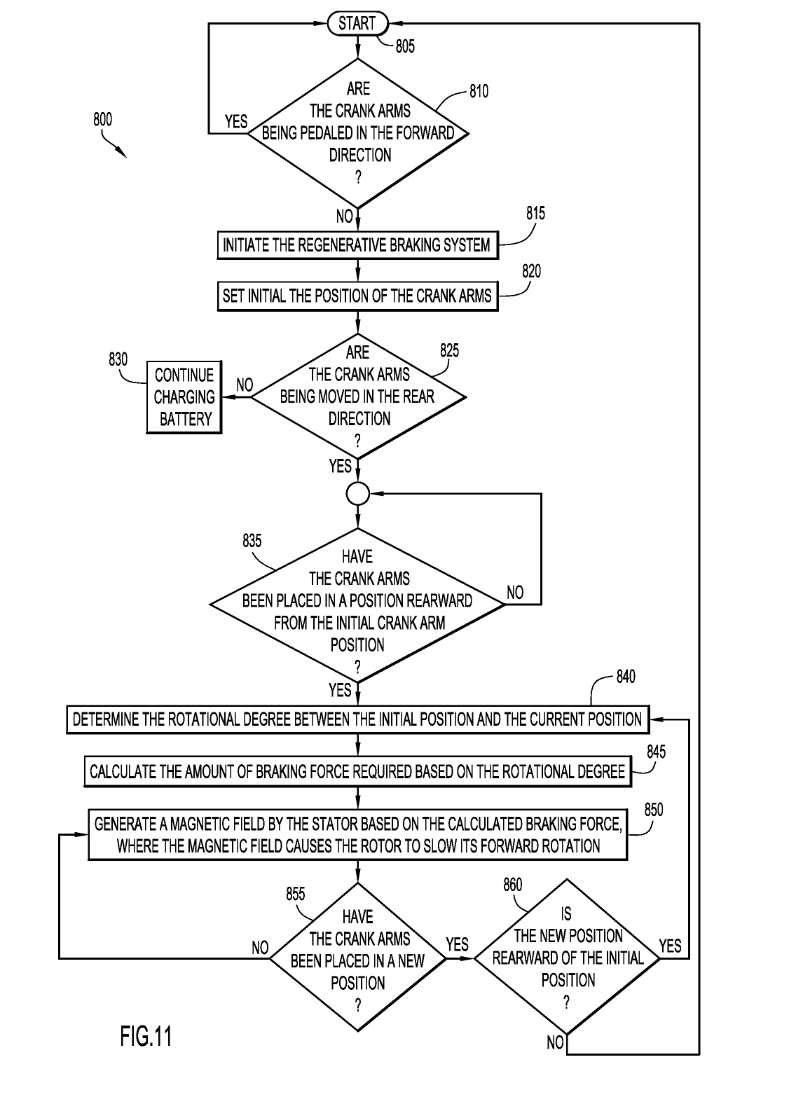

The electronic motor system 20 may further be equipped with a regenerative braking system. Illustrated in FIG. 11 is a flowchart 800 depicting the operations of the regenerative braking system. As explained previously, when force is imparted onto the crank arm 172 in direction A, the pawl will engage the ratchet, causing rotation of the rotor 200 in direction A (illustrated in FIGS. 4 and 5), and thus the sprocket 232, to drive the bicycle chain 140. The ratchet and pawl system also allows the rotor 200 to rotate in direction A (illustrated in FIGS. 4 and 5) when the crank arm 172 and the axle 500 are stationary, enabling the electric motor system 20 to operate without the user having to pedal the bicycle 10. In addition, when force is imparted onto the crank arm 172 in the rearward direction, the pawl will not engage the ratchet, and does not cause the rotor 200 to rotate in any direction. When the bicycle 10 is coasting, the battery 600 is recharged by the electric current created by the rotation of the rotor 200 about the stator 300 by the rear wheel 130. The software controlling the regenerative braking system may be stored on the electronic device 700. As illustrated in the flowchart 800, at block 805, the electronic device 700 begins determining whether the regenerative braking system needs to be initiated and operated. At block 810, the system determines if the crank arms 172 are being pedaled in the forward direction. The system may utilize the pedal sensors, described previously, to determine the movement of the crank arms 172. If the crank arms 172 are being pedaled in the forward direction, then the user of the bicycle 10 is driving the bicycle 10 to some degree. However, if at block 810, the crank arms 172 are not being pedaled in the forward direction, then at block 815 the regenerative braking system is initiated. Thus, rotation of the rotor 200 around the stator 300 by the coasting bicycle 10 creates a current that charges the battery 600. At block 820, the system sets the initial rotational or phase position of the crank arms 172 at the location of the crank arms 172 when the crank arms 172 stopped rotating in the forward position. The system may utilize the pedal sensors, described previously, to determine the rotational position of the crank arms 172.

At block 825, the system determines if the crank arms 172 have been moved in the rearward direction from the initial rotational position of the crank arms 172. If the crank arms 172 have not been moved in the rear direction, then at block 830, the electronic current created by rotation of the rotor 200 around the stator 300 by the coasting bicycle 10 continues to create the current that charges the battery 600. However, if at block 825 the crank arms 172 are being rotated in the rearward direction, then at block 835, the system determines if the crank arms 172 have been placed in a rotational position rearward from the initial rotational position of the crank arms 172. If the crank arms 172 have not yet been placed, then the system continues to loop the query at block 835 until the crank arms 172 have been placed in a rotational position rearward from the initial rotational position. If at block 835, the crank arms 172 have been placed in a new rotational position rearward from the initial rotational position, then at block 840, the system determines the rotational degree between the initial rotational position and the current rotational position. At block 845, the system then calculates the amount of braking force required based on the rotational degree determined at block 840. The user of the bicycle 10 may indicate the amount of electronic braking force by how far the crank arms 172 have been rotated in the rearward rotational position. Thus, farther the crank arms 172 have been rotated in the rearward direction from the initial rotational position, the larger the rotational degree between the current rotational position and initial rotational position of the crank arms 172, and therefore, the larger the braking force. At block 850, the stator 300 may create a magnetic field based on the calculated required braking force, where the magnetic field causes the rotor 200 to decelerate its rotation in the forward direction A (illustrated in FIGS. 4 and 5). As rotation of the rotor 200 is slowed due to the magnetic field, the rotation of the rear wheel 130 is reduced or slowed because of the fixed sprocket 132 on the rear wheel 130 and the chain 140 coupled to the sprocket 232 of the rotor 200 and the sprocket 132 on the rear wheel 130. Thus, decelerating or slowing the rotation of the rotor 200 slows the speed of the bicycle 10.

At block 855, the system determines if the crank arms 172 have been placed in a new rotational position. If at block 855, the rotational position of the crank arms 172 has not been changed, then the system continues cause the stator 300 to create the magnetic field at the previous magnitude to slow the rotation of the rotor 200. However, at block 855, the rotational position of the crank arms 172 have been changed, the system, at block 860, determines if the new rotational position of the crank arms 172 is rearward of the initial rotational position set at block 820. If, at block 860, the new rotational position of the crank arms 172 is not in a rotational position rearward from the initial rotational position, then the crank arms 172 have been rotated to a rotational position forward of the initial rotational position, indicating that the user of the bicycle 10 no longer is braking or requiring the bicycle 10 to slow down. The user of the bicycle 10 may be again pedaling the crank arms 172 in the forward position, driving the bicycle 10. Thus, the system returns to block 805, where the system will determine when the crank arms 172 have no longer been rotated in the forward direction. However, if, at block 860, the new rotational position of the crank arms 172 is a rotational position rearward from the initial rotational position, then the system returns to block 840 to determine the rotational degree between the current position of the crank arms 172 and the initial rotational position. The system then recalculates a new braking force at block 845, and generates a magnetic field by the stator 300 at block 850 as described previously.

The bicycle may be equipped with lights on the rear of the bike. When the bicycle has begun to decelerate due to the regenerative braking system, the system may cause the rear lights to light up, similar to that of the brake lights of a vehicle. In addition, these rear lights may be red.

It is also to be understood that the electric motor and bicycle of the present invention, or portions thereof may be fabricated from any suitable material or combination of materials, such as plastic, foamed plastic, wood, cardboard, pressed paper, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof

It is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. An apparatus comprising:
a frame with a first side and a second side;
at least one wheel rotatably coupled to the frame, the at least one wheel including a first sprocket;
an axle including a first end and a second end, the axle being disposed through the frame with the first end of the axle extending from the first side of the frame and the second end of the axle extending from the second side of the frame, the axle being configured to rotate with respect to the frame;
a first crank arm operatively coupled to the first end of the axle, the first crank arm configured to rotate to the axle when the first crank arm is rotated;
a second crank arm operatively coupled to the second end of the axle, the second crank arm configured to rotate the axle when the second crank arm is rotated, the first crank arm and the second crank arm are configured to rotate simultaneously;
a first motor portion disposed around the first end of the axle between the first side of the frame and the first crank arm, the first motor portion including a stator, a rotor, and a second sprocket disposed around the rotor;
a second motor portion disposed around the second end of the axle between the second side of the frame and the second crank arm, the second motor portion including a battery in electronic communication with the first motor portion; and
a chain coupled to the first sprocket and the second sprocket, wherein rotation of the rotor causes the chain to rotate the wheel, acceleration of the rotation of the rotor accelerates the rotation of the wheel, and deceleration of the rotation of the rotor decelerates the rotation of the wheel.

2. The apparatus of claim 1, wherein the first motor portion is a brushless DC motor.

3. The apparatus of claim 1, wherein the rotor is disposed around the stator and configured to rotate about the stator.

4. The apparatus of claim 3, wherein the first motor portion further includes a sealing plate disposed adjacent to the rotor and stator and configured to prevent moisture and objects from entering the first motor portion.

5. The apparatus of claim 1, wherein the first motor portion has a first weight and the second motor portion has a second weight, the second weight being substantially equal to the first weight.

6. The apparatus of claim 1, wherein the rotor has an approximate weight between 1.5 kg and 2 kg.

7. The apparatus of claim 1, wherein the first motor portion has a first size and the second motor portion has a second size, the second size being substantially equal to the first size.

8. The apparatus of claim 1, wherein the rotor has a diameter of approximately 155 mm to 165 mm.

9. The apparatus of claim 1, wherein at least the first crank arm is operatively coupled to the rotor with a ratchet and pawl system that enables rotation of the first crank arm in the first direction to cause the rotor to rotate in a first direction and enables the first crank arm to rotate in a second direction without causing the rotor to rotate in the second direction.

10. The apparatus of claim 9, wherein the at least one wheel further includes a hub enabling the wheel to rotate when connected to the frame, the first sprocket being fixed to the hub and configured only to rotate with rotation of the hub.

11. The apparatus of claim 10, wherein rotation of the at least one wheel without rotation of the first and second crank arms causes the chain to rotate the rotor to recharge the battery.

12. The apparatus of claim 11, wherein when rotation of the rotor in the first direction and rotation of the first and second crank arms in the second direction causes the first motor portion to decelerate the rotation of the rotor.

13. The apparatus of claim 12, further comprising an electronic device disposed on the frame, the electronic device configured to control power output by the first motor portion.

14. The apparatus of claim 1, wherein the frame further comprises a bottom bracket shell extending from the first side to the second side.

15. The apparatus of claim 14, wherein the axle is inserted through the bottom bracket shell and is configured to rotate within the bottom bracket shell.

16. An apparatus comprising:
an axle having a first end and a second end, the axle being sized and shaped to be disposed within a bottom bracket shell of a bicycle frame so that the axle rotates within the bottom bracket shell with respect to the frame;
a motor including a stator, a rotor, and a sprocket disposed around the rotor, the stator disposed around the axle proximate to the first end of the axle, the rotor coupled to the first end of the axle;
a battery disposed around the axle proximate to the second end of the axle, the battery being electronically connected to the motor;
wherein when the axle is disposed within the bottom bracket shell of the bicycle frame, the motor and the battery are disposed proximate to the bottom bracket shell of the bicycle.

17. The apparatus of claim 16, further comprising:
a first crank arm coupled to the first end of the axle and a second crank arm coupled to the second end of the axle, wherein rotation of the first and second crank arms rotate the axle.

18. The apparatus of claim 17, wherein at least the first crank arm is operatively coupled to the rotor with a ratchet and pawl system that enables rotation of the first crank arm in the first direction to cause the rotor to rotate in a first direction and enables the first crank arm to rotate in a second direction without causing the rotor to rotate in the second direction.

19. The apparatus of claim 16, wherein the motor has a first weight and first size and the battery has a second weight and a second size, the second weight being substantially equal to the first weight, and the second size being substantially equal to the first size.

20. The apparatus of claim 16, wherein the motor is disposed proximate to a first side of the bottom bracket shell of the bicycle frame and the battery is disposed proximate to a second side of the bottom bracket shell of the bicycle frame when the axle is disposed within the bottom bracket shell of the bicycle frame, the first side being opposite of the second side.
